(19) United States
(12) Patent Application Publication
(10) Pub. No.: US 2023/0383105 A1
(43) Pub. Date: Nov. 30, 2023

(54) Microporous Membrane With Enhanced Electrolyte Wettability

(71) Applicant: Celanese International Corporation, Irving, TX (US)

(72) Inventors: Christian Ohm, Gernsheim (DE); Kirsten Markgraf, Weinheim (DE); Argiri Tsami-Schullte, Kelkheim (DE); Fangfang Tao, Shanghai (CN)

(21) Appl. No.: 18/250,896

(22) PCT Filed: Oct. 28, 2020
(86) PCT No.: PCT/CN2020/124374

§ 371 Date: Apr. 27, 2023

(51) Int. Cl. C08L 23/06; C08J 3/075; C08J 9/28; C08J 9/36; C08K 3/22; C08K 5/06; H01M 50/446; H01M 50/417; H01M 50/434; H01M 50/406

(52) U.S. Cl. CPC C08L 23/06; C08J 3/075; C08J 9/283; C08J 9/36; C08K 3/22; C08K 5/06; H01M 50/446; H01M 50/417; H01M 50/434; H01M 50/406; C08L 2207/062; C08L 2205/06; C08L 2205/025; C08L 2205/03; C08K 2003/2227; C08J 2323/06; C08J 2451/06; C08J 2423/08; B01D 69/148

(57) ABSTRACT

A polymer composition for producing gel extruded articles is described. The polymer composition contains polyethylene particles combined with a plasticizer and one or more surface tension reducing techniques. In one aspect, the surface tension reducing technique includes adding a filler or chemical component to the polyethylene polymer for increasing wettability. Alternatively, the surface tension reducing technique can be a surface treatment, such as a plasma treatment. Polymer articles made in accordance with the present disclosure can have dramatically increased wettability properties. In one embodiment, the polymer composition is used to form a porous membrane for use as a separator in electronic devices.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane and may be stretched in one or two directions. After the article is formed, all of the solvent may be removed from the product.

Membranes made from polyethylene polymers through gel-processing can be formed to have many beneficial properties. For instance, the membranes can be formed with micro-pores. Microporous polyethylene membranes formed through gel-processing, for instance, are particularly well suited for use as a separator in a battery, such as a lithium ion battery. The microporous membrane, for instance, can separate an anode from a cathode and prevent a short circuit between the active battery components. At the same time, the microporous membrane permits ions to pass through due to the porous nature of the material. The ion permeability characteristics of the microporous polyethylene membrane makes the material particularly well suited for regulating electrochemical reactions within the battery.

In view of the above, one of the important characteristics of lithium ion battery membranes is the compatibility between the membrane and the electrolyte solution. In this regard, the present disclosure is directed to an improved method for increasing the wettability characteristics of membranes that can be incorporated into lithium ion batteries. The present disclosure is also directed to polymer articles, particularly membranes, that have improved wettability characteristics.

### SUMMARY

In general, the present disclosure is directed to polyolefin compositions well suited for gel-processing applications. More particularly, the present disclosure is directed to a polymer composition containing a high density polyethylene polymer well suited for producing microporous, ion permeable membranes that may be used as separators in batteries. In accordance with the present disclosure, the polymer composition is formulated so as to have improved wettability characteristics, particularly with respect to the electrolyte solution found in lithium ion batteries. The improved wettability characteristics increase the mobility of ions contained within the lithium ion battery which increases battery efficiency and lifetime.

In one embodiment, the present disclosure is directed to a polymer composition for producing gel extruded articles. The polymer composition comprises a plasticizer, high density polyethylene particles and a surface tension reducing additive that increases the wettability of the polymer composition and of articles made from the composition. The surface tension reducing additive can comprise a hydrophilic inorganic filler or hydrophilic organic polymer particles. The surface tension reducing additive can be incorporated into the polymer composition (including the high density polyethylene particles and the plasticizer) in an amount from about 0.1% to about 40% by weight, such as in an amount from about 5% to about 35% by weight, such as in an amount from about 10% to about 30% by weight.

In one aspect, the surface tension reducing additive can be a fatty alcohol glycol ether, an ethylene vinyl alcohol copolymer, an ethylene glycidyl methacrylate copolymer, an ethylene acrylic acid copolymer, a grafted copolymer of polyethylene and maleic acid anhydride, or mixtures thereof. Alternatively or in addition to the above additives, the surface tension reducing additive can also comprise aluminum oxide or aluminum hydroxide particles.

In general, the one or more surface tension reducing additives are incorporated into the polymer composition in an amount sufficient to reduce a contact angle of the polymer composition when measured against water of greater than about 5%, such as greater than about 8%, such as greater than about 10%, such as greater than about 12%, such as greater than about 15%. For example, the polymer composition of the present disclosure can display a contact angle when measured against water of less than about 102°, such as less than about 98°, such as less than about 95°.

In one particular aspect, the surface tension reducing additive comprises a grafted copolymer of polyethylene and maleic acid anhydride. The polyethylene grafted with the maleic acid anhydride can be a linear low density polyethylene or can be a high density polyethylene. For example, the polyethylene can have a molecular weight of greater than about 300,000 g/mol, such as greater than about 500,000 g/mol, such as greater than about 700,000 g/mol. The maleic acid anhydride can be incorporated into the copolymer in an amount greater than about 1.5% by weight, and generally in an amount less than about 5% by weight. In one embodiment, the polymer composition contains the grafted copolymer of polyethylene and maleic acid anhydride in an amount from about 15% to about 30% by weight.

In one embodiment, the surface tension reducing additive can be a hydrophilic agent that couples to the polyethylene resin during the manufacture of the resin or during melt processing of the membrane. The hydrophilic chemical agent, for instance, can include functional chemical groups that either increase the polarity of the polyethylene polymer or undergo a chemical reaction with other polar molecules that increases the wettability of the resulting membrane. Examples of hydrophilic chemical agents include maleic acid anhydride, glycidyl methacrylate, or acrylic acid.

In still another embodiment, the wettability of the membrane can be increased through post-treatment of the surface of the membrane. For instance, the membrane can be plasma treated, subjected to corona discharge, e-beam treated, gamma ray treated, treated with ultraviolet light, and/or stream treated. In one embodiment, one or more surface tension reducing agents may be used in combination with a surface treatment.

The high density polyethylene particles used to produce the membrane can, in one embodiment, have an average particle size by volume of less than about 150 microns, such as less than about 125 microns, and generally greater than about 50 microns.

In general, the polymer composition contains the high density polyethylene resin in an amount up to about 50% by weight. The plasticizer, for instance, can be present in the composition in an amount greater than about 50% by weight, such as in an amount greater than about 60% by weight, such as in an amount greater than about 70% by weight, such as in an amount greater than about 80% by weight, such as in an amount less than about 90% by weight. Various different materials can be used as the plasticizer. For instance, the plasticizer may comprise a mineral oil, a paraffinic oil, a hydrocarbon oil, an alcohol, or the like. For instance, the plasticizer may comprise decaline, xylene, dioctyl phthalate, dibutyl phthalate, stearyl alcohol, oleyl alcohol, decyl alcohol, nonyl alcohol, diphenyl ether, n-decane, n-dodecane, or mixtures thereof. In one embodiment, the plasticizer may comprise a C5-C12 hydrocarbon, such as a C5-C12 saturated hydrocarbon. For example, the plasticizer may comprise heptane, hexane, a paraffin, or the like.

In one embodiment, the high density polyethylene used to produce the particles can have a relatively high molecular weight. The use of higher molecular weight polyethylene particles may be beneficial, especially in applications where greater strength properties are needed or desired. For example, the polyethylene used to produce the particles can have a molecular weight of greater than about 500,000 g/mol, such as greater than about 650,000 g/mol, such as greater than about 1,000,000 g/mol, such as greater than about 1,500,000 g/mol, and less than about 4,000,000 g/mol, such as less than about 3,500,000 g/mol. In one embodiment, the polyethylene used to produce the particles comprises a Ziegler-Natta catalyzed high molecular weight polyethylene. In one embodiment, the composition only contains a single polyethylene polymer.

The present disclosure is also directed to polymer articles formed from the above polymer composition. The polymer articles can be produced through a gel extrusion or gel-spinning process. Polymer articles made in accordance with the present disclosure include fibers, films, such as membranes, or the like.

During the formation of polymer articles, a significant portion of the plasticizer is removed. For example, in one aspect, greater than 95% by weight, such as greater than about 98% by weight of the plasticizer is removed in forming the polymer article. Consequently, polymer articles made in accordance with the present disclosure generally contain the high density polyethylene combined with one or more surface tension reducing additives. For example, the resulting polymer article can contain the high density polyethylene polymer in an amount from about 60% to about 99.5% by weight, such as in an amount from about 65% by weight to about 97% by weight. One or more surface tension reducing additives can comprise the remainder of the polymer article. When the surface tension reducing additive comprises a hydrophilic chemical agent that couples to the polyethylene polymer during melt processing, the surface tension reducing agent can generally be present in the final membrane in an amount from about 0.01% to about 20% by weight, such as from about 0.1% to about 10% by weight.

When the surface tension reducing additive comprises particles that are combined with the polyethylene polymer, the one or more surface tension reducing additives can be present in the polymer article in an amount greater than about 1% by weight, such as in an amount greater than about 3% by weight, such as in an amount greater than about 6% by weight, such as in an amount greater than about 7% by weight, and generally in an amount less than about 30% by weight, such as in an amount less than about 20% by weight. The polymer article can also contain various other additives in addition to the high density polyethylene and the surface tension reducing additive.

The present disclosure is also directed to a process for producing polymer articles. The process includes the steps of forming a gel-like composition from the polymer composition described above. The gel-like composition is then extruded through a die to form a polymer article. The polymer article, for instance, may comprise fibers, a continuous film, or a discontinuous film, such as a porous membrane.

In one embodiment, an extraction solvent, such as dichloromethane is combined with the polymer composition before or during formation of the polymer article. The extraction solvent can be used to facilitate removal of the plasticizer.

Porous membranes made in accordance with the present disclosure can have an excellent blend of physical properties. The porous membranes, for instance, can have excellent tensile strength and can be puncture resistant.

### BRIEF DESCRIPTION OF THE DRAWINGS

The present disclosure may be better understood with reference to the following FIGURE:

FIG. 1 is a cross-sectional view of an electronic device, such as a battery, incorporating a porous membrane made in accordance with the present disclosure.

Repeat use of reference characters in the present specification and drawings is intended to represent the same or analogous features or elements of the present invention.

### Definitions

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40° C. for one minute while nitrogen purge is performed at a flow rate of 20 mL/min then heated from 40° C. to 180° C. at a heating rate of 10° C./min, retained at 180° C. for 5 minutes, and then cooled to 40° C. at a cooling rate of 10° C./min. A baseline is drawn from 60° C. to 150° C. in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123° C. can be determined from the time that requires a quantity of heat measured during an isothermal crystallization measurement at 123° C. to correspond to the half of the peak area in differential scanning calorimetry (DSC) measurement. The test can be conducted using a DSC Q2000 calorimeter available from TA Instruments.

Contact angle measurements are performed on a Kruss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

In addition to contact angle, the wettability of a membrane made in accordance with the present disclosure can also be tested according to the wettability test as follows.

A membrane sample (50×15 mm) is sandwiched between two stainless steel sheets (76×30 mm) each having a hole of 20 mm diameter in the middle. This arrangement is placed under a light microscope (Olympus BX 41) equipped with a 2.5 X objective and a CCD camera (Olympus UC30). A 1 μl droplet of propylene carbonate is placed on the exposed area of the membrane sample using an Eppendorf pipette. Immediately, a through-light image of the droplet and surrounding membrane area is recorded using an imaging software (Stream Motion). Over the following 10 minutes, images of the same spot are recorded every 30 seconds.

The resulting series of images shows that the membrane area around the droplet becomes transparent (indicated by higher brightness in this area). Over time, the transparent area resembling a ring around the droplet grows in size. The diameter of this ring (both in MD and TD direction of the membrane) is measured using the imaging software for every image in the time series. The result of this is two plots of transparent area diameter (for both MD and TD) versus time. A faster increase in diameter of the transparent area is an indicator for better wettability of the membrane with the electrolyte solvent and is desired.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition well suited for producing gel extruded articles, such as fibers and films, including porous membranes. The polymer composition contains a polyethylene resin, such as high density polyethylene particles, combined with a plasticizer and one or more surface tension reducing additives. The surface tension reducing additives can dramatically reduce surface tension and increase the wettability characteristics between polymer articles formed from the polymer composition and liquids, such as water. When producing porous membranes for electronic devices, the one or more surface tension reducing additives can significantly improve the wettability of the membrane when contacted with an electrolyte solution.

In addition to the use of one or more surface tension reducing additives or instead of incorporating one or more surface tension reducing additives into the gel extruded article, in another aspect, the gel extruded article can be surface treated. The surface treatment, such as plasma treatment, can also dramatically improve the wettability characteristics of articles made according to the present disclosure, such as membranes.

The use of one or more surface tension reducing techniques in accordance with the present disclosure can provide various advantages and benefits, especially when forming membranes for lithium ion batteries. For example, improved wettability helps reduce the battery membrane soaking time, which leads to higher productivity. In addition, the increased wettability with the electrolyte solution increases the mobility of the ions, such as the lithium ions, which can significantly increase battery lifetime.

Various different surface tension reducing techniques may be used in accordance with the present disclosure. For instance, the surface tension reducing additive can be a hydrophilic inorganic filler. Alternatively, the surface tension reducing additive can be a hydrophilic organic polymer that can be in the form of particles combined with the matrix polymer that is used to form the polymer article. In one aspect, one or more hydrophilic inorganic fillers can be combined with one or more hydrophilic organic polymers and combined with the matrix polymer. In an alternative aspect, the surface tension reducing additive can be a hydrophilic chemical agent that is combined with the polyethylene resin during melt processing. The hydrophilic chemical agent can couple (e.g. bond, graft, etc) to the polyethylene polymer in a manner that forms functional hydrophilic chemical groups on the surface for increasing the wettability of the final product. In still another aspect, polymer articles of the present disclosure, such as membranes, can be surface treated after being formed using, for instance, a plasma treatment, corona discharge, e-beam treatment, gamma ray treatment, UV treatment, steam treatment, or combinations thereof.

The polymer composition of the present disclosure contains a polyethylene polymer that is particularly well suited for combining with one or more surface tension reducing techniques. The polyethylene polymer can be a high density polyethylene polymer that is used to form the primary polymer component and the matrix polymer of the polymer composition. The high density polyethylene has a density of about 0.93 g/cm³ or greater, such as about 0.94 g/cm³ or greater, such as about 0.95 g/cm³ or greater, and generally less than about 1 g/cm³, such as less than about 0.96 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

Polyethylene polymers particularly well suited for use in the present disclosure have a full width at half maximum of a melting endothermic peak when measured with a differential scanning calorimeter of greater than about 6 degrees C., such as greater than about 6.2 degrees C., such as greater than about 6.4 degrees C., such as greater than about 6.5 degrees C., such as greater than about 6.8 degrees C., and generally less than about 9 degrees C. The polyethylene polymer can also have a half-crystallization time period during an isothermal crystallization at 123° C. of greater than about 2 minutes, such as greater than about 2.5 minutes, such as greater than about 3.0 minutes, such as greater than about 3.5 minutes, such as greater than about 4.0 minutes, such as greater than about 4.5 minutes, and generally less than about 12 minutes. In the past, it was believed that polyethylene polymers having shorter times than those described above provided the most optimum results. The present inventors have discovered, however, that selected surface tension reducing additives or selected combinations of surface tension reducing additives can dramatically improve one or more strength properties of porous membranes made from polymer compositions containing polyethylene polymers as described above.

In accordance with the present disclosure, the high density polyethylene polymer is formed into particles and combined with a plasticizer. In one embodiment, the polyethylene particles are made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm^{3.} In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than 200 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high density polyethylene polymer can be less than about 4,000,000 g/mol, such as less than about 3,000,000 g/mol.

In one aspect, the composition or membrane can include only a single polyethylene polymer. The single polyethylene polymer can have an average molecular weight of 500,000 g/mol or greater, such as greater than about 600,000 g/mol and generally less than 2,500,000 g/mol.

The polyethylene may have a viscosity number of from at least 100 mL/g, such as at least 500 mL/g, such as at least 550 mL/g, to less than about 6,000 mL/g, such as less than about mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

In general, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain the high density polyethylene polymer in an amount greater than about 50% by weight, such as in an amount greater than about 60% by weight, such as in an amount greater than about 65% by weight, such as in an amount greater than about 70% by weight, such as in an amount greater than about 75% by weight.

In accordance with the present disclosure, the polymer composition for producing gel extruded articles can contain one or more surface tension reducing additives in combination with the high density polyethylene particles. The one or more surface tension reducing additives can be combined with the polyethylene polymer prior to being combined with the plasticizer or can be combined with the polyethylene polymer and plasticizer at the same time. In one aspect, the one or more surface tension reducing additives can be pre-compounded with the polyethylene polymer to form the polymer particles that are then combined with the plasticizer. In one embodiment, the surface tension reducing additive can be a hydrophilic chemical agent that is combined with the polyethylene polymer in-situ or while in a molten state for increasing the wettability characteristics of the resulting article.

Surface tension reducing additives that may be used in accordance with the present disclosure generally comprise any suitable additive that can be melt processed with the high density polyethylene particles and lower the surface tension of articles made from the polymer composition and/or increase the wettability characteristics of articles made from the composition. The surface tension reducing additive, for instance, can be a hydrophilic inorganic filler, hydrophilic organic polymeric particles, a hydrophilic chemical agent that forms functional hydrophilic chemical groups on the polymer, or combinations thereof.

In one aspect, the surface tension reducing agent can comprise a polyolefin polymer particularly a polyethylene polymer functionalized with an organic acid, such as an organic acid anhydride. For example, the polyolefin polymer, such as a polyethylene polymer, can be modified to include hydrophilic carboxyl groups. The carboxyl groups can be added to the polymer by oxidation, by polymerization, or by grafting. For example, in one aspect, carboxyl-containing unsaturated monomers can be grafted to a polyolefin polymer, such as a polyethylene polymer. The carboxyl-containing unsaturated monomer, for instance, can be maleic acid anhydride.

For example, in one aspect, the surface tension reducing additive can be a polyethylene polymer functionalized with maleic acid anhydride. The polyethylene polymer can be the same as the high density polyethylene polymer that is combined with the surface tension reducing additive or can be a different polyethylene polymer. For example, the polyethylene polymer functionalized with the maleic acid anhydride can be a low density polyethylene polymer, such as a linear low density polyethylene polymer. Alternatively, the polyethylene polymer functionalized with the maleic acid anhydride can be a high density polyethylene polymer. The high density polyethylene polymer can have a molecular weight of greater than about 300,000 g/mol, such as greater than about 500,000 g/mol, such as greater than about 700,000 g/mol, and generally less than about 2,500,000 g/mol.

The polyethylene functionalized with the maleic acid anhydride can contain maleic acid anhydride in an amount generally greater than about 1.5% by weight, such as in an amount greater than about 1.8% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight. The polyethylene functionalized with maleic acid anhydride generally can contain the maleic acid anhydride in an amount less than about 20% by weight, such as in an amount less than about 10% by weight, such as in an amount less than about 8% by weight, such as in an amount less than about 5% by weight. The polyethylene functionalized with maleic acid anhydride can be in the form of a powder or particles that are combined or compounded with the high density polyethylene particles.

In other embodiments, the surface tension reducing additive can be a fatty alcohol glycol ether such as an ethylene-vinyl alcohol copolymer. The surface tension reducing additive can also be an ethylene acrylic acid copolymer. The ethylene acrylic acid copolymer can generally have an acrylic acid content of greater than 5% by weight, such as greater than about 8% by weight, such as greater than about 10% by weight, and generally less than about 30% by weight, such as less than about 20% by weight, such as less than about 15% by weight, such as less than about 12% by weight.

The surface tension reducing additive can be any suitable acrylate polymer and/or a graft copolymer containing an olefin. The olefin polymer, such as polyethylene, can serve as a graft base and can be grafted to at least one vinyl polymer or one ether polymer.

Examples of surface tension reducing additives as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, a surface tension reducing additive can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The surface tension reducing additive may be a linear or branched, homopolymer or copolymer (e.g., random, graft, block, etc.) containing epoxy functionalization, e.g., terminal epoxy groups, skeletal oxirane units, and/or pendent epoxy groups. For instance, the surface tension reducing additive may be a copolymer including at least one monomer component that includes epoxy functionalization. The monomer units of the surface tension reducing additive may vary. For example, the surface tension reducing additive can include epoxy-functional methacrylic monomer units. As used herein, the term (meth)acrylic generally refers to both acrylic and methacrylic monomers, as well as salts and esters thereof, e.g., acrylate and methacrylate monomers. Epoxy-functional (meth)acrylic monomers that may be incorporated in the surface tension reducing additive may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the surface tension reducing additive can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the surface tension reducing additive can be a terpolymer that includes epoxy functionalization. For instance, the surface tension reducing additive can include a methacrylic component that includes epoxy functionalization, an α-olefin component, and a methacrylic component that does not include epoxy functionalization. For example, the surface tension reducing additive may be poly(ethylene-co-methylacrylate-co-glycidyl methacrylate), which has the following structure:

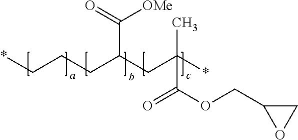

wherein, a, b, and c are 1 or greater.

In another embodiment the surface tension reducing additive can be a random copolymer of ethylene, ethyl acrylate and maleic anhydride having the following structure:

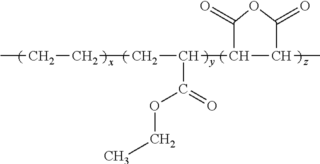

wherein x, y and z are 1 or greater.

The relative proportion of the various monomer components of a copolymeric surface tension reducing additive is not particularly limited. For instance, in one embodiment, the epoxy-functional methacrylic monomer components can form from about 1 wt. % to about 25 wt. %, or from about 2 wt. % to about 20 wt % of a copolymeric surface tension reducing additive. An α-olefin monomer can form from about 55 wt. % to about 95 wt. %, or from about 60 wt. % to about 90 wt. %, of a copolymeric surface tension reducing additive. When employed, other monomeric components (e.g., a non-epoxy functional methacrylic monomers) may constitute from about 5 wt. % to about 35 wt. %, or from about 8 wt. % to about 30 wt. %, of a copolymeric surface tension reducing additive.

The molecular weight of the above surface tension reducing additive can vary widely. For example, the surface tension reducing additive can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In still another embodiment, the surface tension reducing additive can be a surfactant that can be melt processed with the high density polyethylene resin. For example, the surfactant can be a nonionic surfactant that is in the form of a solid at 23 C. In one aspect, for instance, the surface tension reducing additive can be an alkyl polyethylene glycol ether. The alkyl polyethylene glycol ether can be made from linear saturated C10 to C28, such as C16-C18, fatty alcohols. For example, the surfactant can be the reaction product of a fatty alcohol with ethylene oxide. The surfactant can contain a degree of ethoxylation of greater than about 8 mols, such as greater than about 10 mols, such as greater than about 20 mols, such as greater than about 30 mols, such as greater than about 40 mols, and generally less than about 100 mols, such as less than about 80 mols, such as less than about 60 mols.

In still another embodiment, the surface tension reducing additive can be a hydrophilic inorganic filler such as aluminum oxide or aluminum hydroxide. The aluminum oxide, for instance, can have a BET surface area of greater than about 85 m²/g, such as greater than about 90 m²/g, such is greater than about 100 m²/g, and generally less than about 500 m²/g, such as less than about 200 m²/g.

The hydrophilic inorganic filler can generally have a D50 particle size of less than about 30 microns, such as less than about 20 microns, such as less than about 15 microns, such as less than about 10 microns, and generally greater than about 0.1 microns, such as greater than about 0.5 microns, such as greater than about 1 micron, such as greater than about 3 microns, such as greater than about 5 microns.

In another aspect, the surface tension reducing additive can be a hydrophilic chemical agent that couples to the polyethylene polymer during melt processing or in-situ during formation of the polymer for increasing the wettability characteristics of the resulting article. The hydrophilic chemical agent, for instance, can chemically graft to the polyethylene polymer with functional chemical groups that increases the polarity of the polymer. Alternatively, the hydrophilic chemical agent can undergo a chemical reaction with other polar molecules on the polyethylene polymer for reducing surface tension.

In one aspect, for instance, the surface tension reducing additive can be an organic acid anhydride as described above that is combined with the polyethylene polymer during melt processing. For instance, the organic acid anhydride can comprise maleic acid anhydride. Alternatively, the surface tension reducing agent can be an acrylate or a methacrylate, such as glycidyl methacrylate. In still another alternative embodiment, the surface tension reducing agent can comprise an acrylic acid that contacts the polyethylene polymer in molten form and bonds with the polymer.

In still another aspect of the present disclosure, polymer articles made according to the present disclosure can be surface treated in order to improve the wettability characteristics of the article. For example, the polymer article can be surface treated using one of many techniques. Suitable surface treatments that may be used include plasma treatment, corona discharge, e-beam treatment, gamma ray treatment, UV treatment, steam treatment, and combinations thereof. Surface treatment of the polymer articles can be used in combination with one or more of the above described surface tension reducing additives to further increase wettability characteristics.

The amount of one or more surface tension reducing additives incorporated into the polymer composition and into polymer articles made from the composition can vary depending upon various factors. In general, one or more surface tension reducing additives are incorporated into the polymer composition such that porous membranes made from the composition have an increase in wettability. For example, in one embodiment, one or more surface tension reducing additives can be incorporated into the polymer composition such that the polymer composition and articles made from the composition undergo a reduction in contact angle of greater than about 4%, such as greater than about 5%, such as greater than about 7%, such as greater than about 10%, such as greater than about 12%, such as greater than about 15%, such as greater than about 18%, such as greater than about 20%. The contact angle, for instance, can decrease by even greater than about 25%, such as by greater than 30%, such as by greater than about 40% and up to about 60%. The above reduction in contact angle can be observed when testing the polymer composition against any suitable liquid, including water or ethylene glycol.

For example, when tested against water, the polymer composition of the present disclosure containing one or more surface tension reducing additives can display a contact angle of less than about 102°, such as less than about 98°, such as less than about 95°, such as less than about 93°, such as less than about 90°, such as less than about 88°, such as less than about 85°, such as less than about 83°, such as less than about 80°. The contact angle is generally greater than about 50° when tested against water. When tested against ethylene glycol, the polymer composition and articles made from the composition can display a contact angle of less than about 79°, such as less than about 77°, such as less than about 75°, such as less than about 73°, such as less than about 70°, such as less than about 68°, such as less than about 66°, such as less than about 63°, such as less than about 60°. The contact angle when tested against ethylene glycol is generally greater than about 30°.

The actual amount of one or more surface tension reducing agents contained in the polymer composition can depend upon various factors. Polymer articles made according to the present disclosure, for instance, can contain one or more surface tension reducing agents generally in an amount of from about 0.1% to about 40% by weight, including all increments by 1% by weight therebetween. For instance, one or more surface tension reducing agents, when in the form of a filler or particles, can be present in the polymer article in an amount greater than about 2% by weight, such as in an amount greater than about 5% by weight, such as in an amount greater than about 8% by weight, such as in an amount greater than about 10% by weight, such as in an amount greater than about 12% by weight, such as in an amount greater than about 15% by weight, such as in an amount greater than about 17% by weight, such as in an amount greater than about 20% by weight, such as in an amount greater than about 22% by weight, such as in an amount greater than about 25% by weight. One or more surface tension reducing agents are generally contained in the polymer article in an amount less than about 35% by weight, such as in an amount less than about 30% by weight.

When the one or more surface tension reducing agents is in the form of a hydrophilic chemical agent added to the polyethylene polymer in-situ, the resulting polymer article may contain the one or more surface tension reducing agents generally in an amount greater than about 0.01% by weight, such as in an amount greater than about 0.1% by weight, such as in an amount greater than about 0.5% by weight, such as in an amount greater than about 1% by weight, such as in an amount greater than about 2% by weight, such as in an amount greater than about 4% by weight, such as in an amount greater than about 5% by weight, such as in an amount greater than about 7% by weight, and generally in an amount less than about 20% by weight, such as in an amount less than about 10% by weight, such as in an amount less than about 7% by weight, such as in an amount less than about 6% by weight.

As described above, polymer compositions made in accordance with the present disclosure that are used to produce polymer articles contain a high density polyethylene resin, a plasticizer, one or more surface tension reducing agents, and one or more other additives. The plasticizer is contained in the composition in order to facilitate the formation of polymer articles and is then substantially removed from the polymer articles that are formed. When the polymer composition contains from about 50% to about 85% by weight plasticizer, the polymer composition can contain one or more surface tension reducing additives in an amount greater than about 0.01% by weight, such as in an amount greater than about 1% by weight, such as in an amount greater than about 2% by weight, such as in an amount greater than about 2.5% by weight, such as in an amount greater than about 3% by weight, such as in an amount greater than about 5% by weight, such as in an amount greater than about 7% by weight, such as in an amount greater than about 9% by weight, such as in an amount greater than about 10% by weight, such as in an amount greater than about 12% by weight. One or more surface tension reducing additives can be present in the formed articles in an amount less than about 20% by weight, such as in an amount less than about 15% by weight.

In general, any suitable plasticizer can be combined with the other components as long as the plasticizer is capable of forming a gel-like material suitable for gel spinning or extruding. The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high density polyethylene particles and surface tension reducing additive blend with the plasticizer to form a homogeneous gel-like material.

In order to form polymer articles in accordance with the present disclosure, the high density polyethylene particles are combined with one or more surface tension reducing additives and the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polymer mixture to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Polymer articles made in accordance with the present disclosure have numerous uses and applications. For example, in one embodiment, the process is used to produce a membrane. The membrane can be used, for instance, as a battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

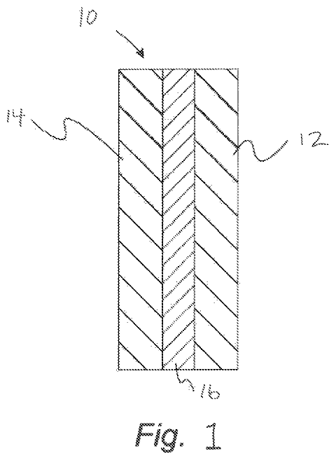

Referring to FIG. 1, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer polymer membrane and does not include a multilayer structure. In one aspect, the single layer polymer membrane may also include a coating. The coating can be an inorganic coating made from, for instance, aluminum oxide or a titanium oxide. Alternatively, the single layer polymer membrane may also include a polymeric coating. The coating can provide increased thermal resistance.

The polymer composition and polymer articles made in accordance with the present disclosure may contain various other additives, such as heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following example. The following example is given below by way of illustration and not by way of limitation. The following experiments were conducted in order to show some of the benefits and advantages of the present invention.

### Example No. 1

Various resin compositions were formulated containing a base resin of high density polyethylene with various surface tension reducing additives. The surface tension reducing additives were blended with high density polyethylene using a tumble blender. The resin compositions were prepared into membranes via gel extrusion, biaxial stretching, and solvent extraction as are conventional.

The polyethylene polymer used in the examples had an average molecular weight of about 700,000 g/mol and an average particle size of about 115 microns. The polymer had a melt flow rate of 0.5 g/10 min and had a density of 0.94 g/cm³. The polymer had a viscosity number of 600 cm 3/g when measured according to ISO Test 1628-3.

The following surface tension reducing techniques were investigated. The loading below is of the final membrane after the plasticizer has been removed.

| Sample | | Loading |
|---|---|---|
| No. | Surface Tension Reducing Additive | (Weight %) |
| 1 | 0 | 0 |
| 2 | Plasma Treatment | 0 |
| 3 | Linear Low Density Polyethylene | 20% |
| | Functionalized With Greater than 1.5% by | |
| | Weight Maleic Acid Anhydride | |
| 4 | Ethylene-Vinyl Alcohol Copolymer | 15% |
| 5 | Ethylene-Vinyl Alcohol Copolymer and Linear | 15% and 10% |
| | Low Density Polyethylene Functionalized With | |
| | Maleic Acid Anhydride | |
| 6 | Ethylene-Vinyl Alcohol Copolymer and | 15% and 5% |
| | Random Ethylene Glycidyl Methacrylate | |
| | Copolymer | |
| 7 | Aluminum Oxide and Linear Low Density | 10% and 10% |
| | Polyethylene Functionalized with Maleic Acid | |
| | Anhydride | |
| 8 | Aluminum Oxide and Random Ethylene- | 10% and 5% |
| | Glycidyl Methacrylate Copolymer | |
| 9 | Aluminum Hydroxide and Linear Low Density | 10% and 10% |
| | Polyethylene Functionalized With Maleic Acid | |
| | Anhydride | |
| 10 | Ethylene Acrylic Acid Copolymer and Random | 15% and 5% |
| | Ethylene- Glycidyl Methacrylate Copolymer | |
| 11 | Ethylene Acrylic Acid Copolymer and Linear | 15% and 10% |
| | Low Density Polyethylene Functionalized with | |
| | Maleic Acid Anhydride | |
| 12 | Ethoxylated C16 to C18 Fatty Alcohol and | 10% and 10% |
| | Linear Low Density Polyethylene | |
| | Functionalized with Maleic Acid Anhydride | |

The blends were gel extruded using a solid content of 30 wt. % resin and paraffin oil at a temperature of from about 190° C. to about 240° C. and a screw speed of 200 rpm. After extrusion, the resulting membrane was solidified on a chill roller set to 40° C. Stretching was performed in a 7×7 ratio (MD/TD) at a temperature of 120° C. Extraction of the stretched membranes was performed in acetone. The membranes were annealed at 130° C. for 10 minutes.

The membranes were then tested for contact angle against ethylene glycol and the following results were obtained.

| Sample | Contact Angle |
|---|---|
| No. | (Ethylene Glycol) |
| 1 | 80 |
| 2 | 63 |
| 3 | 65 |
| 4 | 81 |
| 5 | 81 |
| 6 | 77 |
| 7 | 78 |
| 8 | 78 |
| 9 | 73 |
| 10 | 76 |
| 11 | 69 |
| 12 | 75 |

### Example No. 2

In this example, two different membranes were subjected to a plasma post-treatment process and tested for contact angle. The first membrane had a thickness of 9 microns while the second membrane had a thickness of 20 microns. The membranes were tested for contact angle against water and ethylene glycol. The following results were obtained:

| | 9 um | | 20 um | |
|---|---|---|---|---|
| | | ethylene | | ethylene |
| | water | glycol | Water | glycol |
| | Contact | Contact | Contact | Contact |
| Treatment | angle (°) | angle (°) | angle (°) | angle (°) |
| Before treatment | 116.91 | 91.33 | 118.63 | 90.63 |
| After treatment | 60.84 | 25.81 | 60.53 | 27.93 |

As shown above, the plasma treatment yielded a significant reduction in contact angle between the membrane and the test fluid. The use of a surface treatment technique, such as plasma treatment, is particularly well suited for combining with one or more of the above described tension reducing additives.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

1. A polymer composition for producing gel extruded articles comprising:
a plasticizer;
high density polyethylene particles; and
a surface tension reducing additive that increases a wettability of the polymer composition, the surface tension reducing additive comprising a hydrophilic inorganic filler, hydrophilic organic polymeric particles or a hydrophilic chemical agent that includes hydrophilic chemical groups that has coupled to the high density polyethylene.

2. A polymer composition as defined in claim 1, wherein the surface tension reducing additive comprises a grafted copolymer of polyethylene and maleic acid anhydride.

3. A polymer composition as defined in claim 1, wherein the surface tension reducing additive comprises a grafted copolymer of polyethylene and maleic acid anhydride, a fatty alcohol glycol ether, an ethylene vinyl alcohol copolymer, an ethylene glycidyl methacrylate copolymer, an ethylene acrylic acid copolymer, or mixtures thereof.

4. A polymer composition as defined in claim 1, wherein the surface tension reducing additive comprises aluminum oxide or aluminum hydroxide.

5. A polymer composition as defined in claim 1, wherein the surface tension reducing additive comprises the hydrophilic chemical agent.

6. A polymer composition as defined in claim 1, wherein the surface tension reducing additive comprises aluminum oxide or aluminum hydroxide in combination with a grafted copolymer of polyethylene and maleic acid anhydride, a fatty alcohol glycol ether, an ethylene vinyl alcohol copolymer, an ethylene glycidyl methacrylate copolymer, or an ethylene acrylic acid copolymer.

7. A polymer composition as defined in claim 1, wherein the surface tension reducing additive is present in the composition in an amount from about 5% to about 15% by weight.

8. A polymer composition as defined in claim 1, wherein the surface tension reducing additive is present in the composition in an amount sufficient to reduce a contact angle of a polymer article formed from the polymer composition measured against water in an amount greater than about 5%.

9. A polymer composition as defined in claim 1, wherein a polymer article formed from the polymer composition displays a contact angle measured against water of less than about 102°.

10. A polymer composition as defined in claim 2, wherein the polyethylene of the grafted copolymer of polyethylene and maleic acid hydride is a linear low density polyethylene, a low density polyethylene, or a high density polyethylene.

11. (canceled)

12. (canceled)

13. A polymer composition as defined in claim 2, wherein the grafted copolymer of polyethylene and maleic acid hydride is present in the polymer composition in an amount from about 15-% to about 15% by weight.

14. A polymer composition as defined in claim 1, wherein the high density polyethylene particles have a median particle size by volume of from about 70 microns to about 210 microns.

15. (canceled)

16. (canceled)

17. A polymer composition as defined in claim 1, wherein the high density polyethylene has a molecular weight of greater than about 600,000 g/mol and less than about 4,000,000 g/mol.

18. A polymer composition as defined in claim 15, wherein the composition only contains a single high density polyethylene polymer.

19. (canceled)

20. (canceled)

21. A polymer composition as defined in claim 1, wherein the polymer composition is polypropylene-free.

22. A process for producing polymer articles comprising:
forming the polymer composition as defined in claim 1 into a gel-like composition;
extruding the gel-like composition through a die to form a polymer article, the polymer article comprising a film.

23. (canceled)

24. (canceled)

25. (canceled)

26. A porous membrane comprising:
a high density polyethylene combined with a surface tension reducing additive, the surface tension reducing additive comprising a hydrophilic inorganic filler, hydrophilic organic polymer particles, or a hydrophilic chemical agent that has coupled to the high density polyethylene, the porous membrane displaying a contact angle when measured against water of less than about 102°.

27. A porous membrane as defined in claim 26, wherein the surface tension reducing agent comprises a grafted copolymer of polyethylene and maleic acid anhydride.

28. A porous membrane as defined in claim 26, wherein the surface tension reducing additive is present in the membrane in an amount from about 0.1% to about 40% by weight.

29. A porous membrane as defined in claim 26, wherein the membrane has been subjected to a surface treatment.

30. A porous membrane as defined in claim 29, wherein the surface treatment comprises a plasma treatment.

31. A porous membrane as defined in claim 29, wherein the surface treatment comprises corona discharge, e-beam treatment, gamma ray treatment, ultraviolet light treatment, or steam treatment.
